(19) United States
(12) Patent Application Publication
(10) Pub. No.: US 2025/0229778 A1
(43) Pub. Date: Jul. 17, 2025

(54) METHOD AND DEVICE FOR LONGITUDINALLY GUIDING A MOTOR VEHICLE

(71) Applicant: Volkswagen Aktiengesellschaft, Wolfsburg (DE)

(72) Inventors: Daniel Münning, Braunschweig (DE); Jonas Kaste, Braunschweig (DE); Hendrik Oschlies, Braunschweig (DE)

(21) Appl. No.: 19/015,259

(22) Filed: Jan. 9, 2025

(30) Foreign Application Priority Data
Jan. 11, 2024 (DE) 102024200245.3

(51) Int. Cl. B60W 30/12; B60W 10/08; B60W 10/20; B60W 50/14; B60W 60/00

(52) U.S. Cl. CPC B60W 30/12; B60W 10/08; B60W 10/20; B60W 50/14; B60W 60/001; B60W 2540/223; B60W 2552/53

(57) ABSTRACT

Technologies and techniques for laterally guiding a motor vehicle include a device with at least one assistance system, at least one surroundings sensor system, and/or access to a database of swarm data. The device is configured to detect driving lane boundaries based on data from the surroundings sensor system and/or swarm data. The assistance system generates steering instructions for a steering system, based on the data, to maintain the motor vehicle on a target trajectory. The motor vehicle driver may adapt the target trajectory, and the assistance system generates steering instructions to maintain the adapted target trajectory. The device identifies areas, referred to as operational design domains (ODDs), where the motor vehicle driver is permitted to remove their hands from the steering handle. A sensor system detects whether hands are removed. If no hands are detected, or upon entering an ODD, the system transitions to a predefined target trajectory.

### RELATED APPLICATIONS

The present application claims priority to German Patent Application No. 10 2024 200 245.3, filed Jan. 11, 2024, to Münning et al., the contents of which are incorporated by reference in its entirety herein.

### TECHNICAL FIELD

The present disclosure relates to a method and to a device for laterally guiding a motor vehicle.

### BACKGROUND

Various methods for assisting or autonomously providing lateral guidance of a motor vehicle are known, including, for example, lane-keeping assistance systems. These systems detect driving lane boundaries using a surroundings sensor system and generate steering torque to maintain the motor vehicle within the driving lane. Typically, the system aims to keep the motor vehicle centered in the driving lane. However, this alignment may be adjusted when navigating curves, such as by increasing steering towards the inside of the curve. In some configurations, the driver may also adapt the target trajectory within certain limits, allowing the trajectory to deviate slightly from the center of the driving lane, offset by a few centimeters to the left or right.

It has also been proposed to define specific areas in which enhanced assistance is provided. These areas, often referred to as operational design domains (ODDs), are typically characterized by easily recognizable driving lane boundaries and relatively straight, clearly visible route sections. Within such an ODD, the motor vehicle driver may be permitted to remove their hands from the steering handle, with the system autonomously taking over lateral guidance. Driver monitoring in these scenarios may be performed through an alternative system, such as a driver monitoring system within the passenger compartment.

### SUMMARY

The technical problem underlying the present disclosure is to provide a method that integrates hands-off driving into existing methods and to develop a suitable device.

Aspects of this problem are addressed by the subject matter of the independent claims. Additional advantageous configurations of the present disclosure are outlined in the dependent claims.

In some examples, a method for laterally guiding a motor vehicle is disclosed, implemented through an assistance system. The method involves detecting driving lane boundaries using at least one surroundings sensor system and/or swarm data. Based on the data from the at least one surroundings sensor system and/or the swarm data, the assistance system generates steering instructions for a steering system to maintain the motor vehicle on a target trajectory. The steering instructions may include curvatures, toothed rack positions, or steering angles, which are executed by the steering system. The surroundings sensor system preferably includes at least one camera and may additionally or alternatively incorporate radar, LIDAR, and/or ultrasonic sensors.

The motor vehicle driver may adapt the target trajectory, and the assistance system subsequently generates steering instructions for the steering system based on the data from the surroundings sensor system and/or swarm data to maintain the vehicle on the adapted target trajectory. This adaptation can be carried out in various ways, which may be provided to the driver as options. For instance, the adaptation may be entered alphanumerically or using a push button. Alternatively, the adaptation can be learned by the assistance system when the driver maintains the motor vehicle on the desired trajectory for a predefined time or distance, overriding the initial target trajectory.

In some examples, a device for laterally guiding a motor vehicle is disclosed, comprising at least one assistance system and at least one surroundings sensor system and/or access to a database of swarm data. For example, the swarm data may be stored in a cloud server, and the device retrieves the required data for the current surroundings. The device is configured to detect driving lane boundaries based on the data from the surroundings sensor system and/or swarm data. The assistance system then generates steering instructions for a steering system to maintain the motor vehicle on the target trajectory.

The device further allows the motor vehicle driver to provide an adaptation of the target trajectory. The assistance system generates steering instructions based on the surroundings sensor system data and/or swarm data to maintain the motor vehicle on this adapted target trajectory. Additionally, the device is configured to identify areas where hands-off or hands-free driving is permitted. It includes at least one sensor system to detect whether the driver has removed their hands from the steering handle. If no hands are detected within such an area, the device transitions from the adapted target trajectory to a target trajectory predefined by the assistance system, transmitting the corresponding steering instructions to the steering system. Alternatively, the system may automatically transition to the target trajectory upon entering such an area, regardless of whether the driver's hands are on the steering handle.

The further configurations of the device incorporate the content and function of the methods disclosed herein.

### BRIEF DESCRIPTION OF THE DRAWINGS

The present disclosure will be described in more detail hereafter based on a preferred exemplary embodiment. In the drawings:

FIG. 1 shows a schematic block diagram of a device for laterally guiding a motor vehicle, according to some aspects of the present disclosure;

FIG. 2 shows a schematic, exemplary representation of a target trajectory of an assistance system and an adapted target trajectory of a motor vehicle driver, according to some aspects of the present disclosure; and

FIG. 3 shows a flow chart of a method for laterally guiding a motor vehicle, according to some aspects of the present disclosure.

### DETAILED DESCRIPTION

In various examples disclosed herein, areas are identified where the motor vehicle driver is permitted to remove their hands from the steering handle. These areas may be stored in a digital map or made available by a server. Additionally, or alternatively, the surroundings sensor system may determine such areas. A sensor system is used to detect whether the motor vehicle driver has removed their hands from the steering handle. For example, the sensor system may include a capacitive steering wheel, a passenger compartment camera, or a steering torque sensor capable of recognizing hands-on/hands-off scenarios.

If the assistance system detects within such an area, referred to as an operational design domain (ODD), that the driver has removed their hands from the steering handle, it transitions from the adapted target trajectory to a target trajectory defined by the assistance system. This transition ensures the system can establish a trajectory optimized for automated driving. Notably, the target trajectory within the area may differ from the previously defined target trajectory. For example, it could be derived based on the adapted target trajectory. The transition is preferably gradual, with the assistance system adapting the steering instructions over a predefined time (e.g., 5 seconds) or distance (e.g., 100 meters) to steer the vehicle from the adapted target trajectory to the target trajectory of the assistance system. This smooth transition enhances driver comfort and reduces potential irritation caused by sudden changes.

Alternatively, the assistance system may automatically switch to its target trajectory upon entering such an area, regardless of whether the driver's hands remain on the steering handle.

The first alternative allows the driver to retain control over their adapted target trajectory for as long as possible, while the second alternative provides a quicker and simpler transition.

In the first alternative, the transition occurs only after detecting a hands-off scenario. In one configuration, the adapted target trajectory is discarded after the transition to the system-defined target trajectory. This prevents confusion for the driver, particularly in cases where the adapted trajectory was situationally defined (e.g., due to specific traffic conditions), and the driver might be surprised by a return to the adapted trajectory after hands-off driving when the original traffic situation no longer exists.

Alternatively, the adapted target trajectory may be stored and automatically re-engaged after the hands-off driving period ends. This option is advantageous when the adapted trajectory reflects the driver's general preference (e.g., driving slightly off-center to the right within the lane).

The motor vehicle driver may be given the option to configure whether the adapted target trajectory should be stored or discarded. This allows the system to align with the driver's preferences.

In another example, the motor vehicle driver can adapt the target trajectory of the assistance system or an adapted target trajectory while within an area, provided the driver's hands remain on the steering handle.

In another example, the adaptation of the target trajectory within an area may differ from the adaptation process outside the area. For instance, transitioning from a first adapted target trajectory to a second adapted target trajectory might follow the same process inside and outside the area. However, transitioning from a system-defined target trajectory after hands-off driving to a new adapted target trajectory could differ. For example, the driver may need to steer against the system-defined trajectory for a longer or shorter duration before the new adapted target trajectory is accepted.

In yet another example, if it is detected outside an area that the driver has removed their hands from the steering handle, the system may maintain the adapted target trajectory while prompting the driver to place their hands back on the steering handle. If the driver fails to comply within a predefined time, the system may transition to a system-defined target trajectory and prepare for an emergency stop.

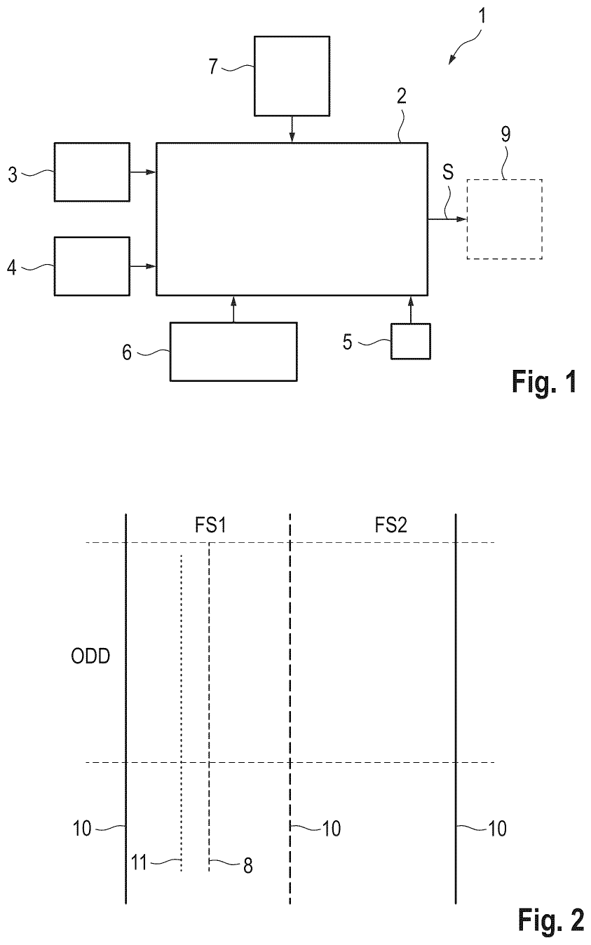

FIG. 1 illustrates a schematic block diagram of a device 1 for laterally guiding a motor vehicle, according to some aspects of the present disclosure. The device 1 includes an assistance system 2, at least one surroundings sensor system 3, and at least one sensor system 4 configured to detect whether the motor vehicle driver has their hands on a steering handle (hands-on/hands-off recognition). Additionally, the device 1 comprises a unit 5 for position determination, an input unit 6, and a database 7 storing information about areas, also referred to as operational design domains (ODDs), where the motor vehicle driver is permitted to remove their hands from the steering handle. The assistance system 2 is designed to generate steering instructions to maintain the motor vehicle on a target trajectory 8 (see FIG. 2). These instructions are implemented by a steering system 9 of the motor vehicle via control commands S, such as curvatures or toothed rack positions.

The operation of the device 1 is further explained with reference to FIG. 2, which schematically represents two driving lanes FS1 and FS2 of an expressway. Using the surroundings sensor system 3, the device 1 detects driving lane boundaries 10. Based on these boundaries, the assistance system 2 calculates a target trajectory 8, which is typically positioned in the center of the driving lane FS1. The assistance system 2 generates steering torque to maintain the motor vehicle on this target trajectory 8. The motor vehicle driver can define an adapted target trajectory 11 via the input unit 6. This trajectory may deviate from the target trajectory 8 by a predefined distance, such as positioning the vehicle closer to the left driving lane boundary 10. The driver can input the adaptation by actively steering the vehicle against the assistance system 2 for a set time or distance or by entering parameters, such as direction and offset, into the input unit 6. Once the adapted target trajectory 11 is established, the assistance system 2 generates steering instructions to maintain the motor vehicle on this trajectory.

The sensor system 4 performs hands-on/hands-off recognition to detect whether the driver's hands are on the steering handle. If the driver removes their hands, the assistance system 2 issues a warning—such as an acoustic or visual alert—prompting the driver to resume control. While waiting for compliance, the assistance system 2 continues to maintain the adapted target trajectory 11. If the driver fails to respond within a predefined time (e.g., 10 seconds), the assistance system 2 switches to the target trajectory 8 and, if necessary, prepares for an emergency stop.

In certain ODDs, as indicated by two horizontal lines in FIG. 2, hands-off operation is permitted. Information about these areas is stored in the database 7, which may reside in the motor vehicle's memory or be accessed via a service provider. Using data from the unit 5, the vehicle determines whether it is approaching an ODD and informs the driver, for example, through visual or acoustic signals. If the driver removes their hands upon entering the ODD, the sensor system 4 detects this, and the assistance system 2 transitions to the target trajectory 8. At the end of the ODD, the system requests the driver to resume control of the steering handle while maintaining the target trajectory 8. The target trajectory 8 followed during hands-off operation within an ODD is preferably the original target trajectory 8, but it may also be a modified version incorporating elements of the adapted target trajectory 11.

The device 1 behaves differently depending on whether hands-off recognition occurs within or outside an ODD. Within an ODD, the driver may adapt the target trajectory 8 by re-engaging with the steering handle. This allows the driver to redefine an adapted target trajectory 11 even during hands-off operation. In one configuration, the process of adapting the target trajectory within an ODD may differ from that outside an ODD. For instance, transitioning from the system-defined target trajectory to a new adapted trajectory might require the driver to steer for a longer or shorter duration within an ODD. If hands-off is detected outside an ODD, the adapted target trajectory 11 is maintained while the driver is prompted to resume control. Failure to respond within a predefined time results in a switch to the target trajectory 8 and the preparation of an emergency stop.

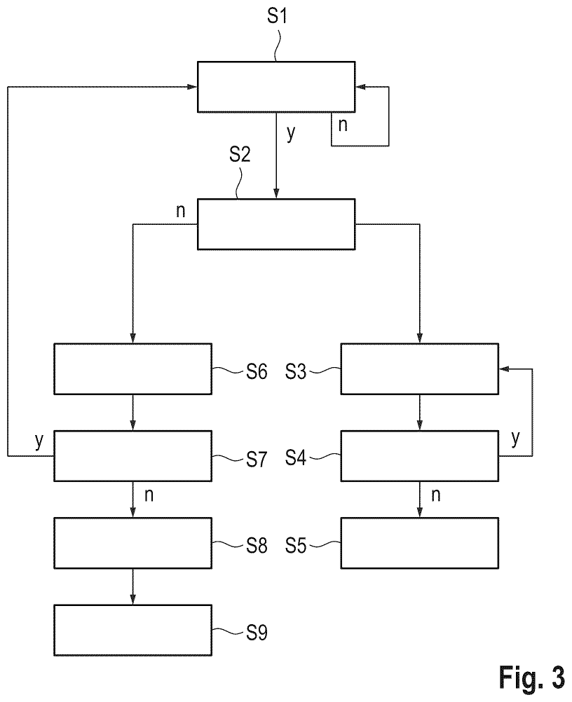

FIG. 3 presents a flow chart of the method according to some aspects of the present disclosure. In step S1, the system checks whether the driver has removed their hands from the steering handle. If so, step S2 determines whether the vehicle is within an ODD. If the vehicle is in an ODD, step S3 transitions the vehicle from the adapted target trajectory 11 to the target trajectory 8. Step S4 monitors whether the vehicle remains in the ODD. Upon leaving the ODD, step S5 prompts the driver to resume control of the steering handle. If step S2 determines that the vehicle is outside an ODD, step S6 prompts the driver to place their hands on the steering handle. Step S7 checks whether the driver complies. If the driver does not respond, step S8 transitions the vehicle to the target trajectory 8, and step S9 prepares for an emergency stop.

### LIST OF REFERENCE SIGNS

1 device
2 assistance system
3 surroundings sensor system
4 sensor system
5 unit
6 input unit
7 database
8 target trajectory
9 steering system
10 driving lane boundary
11 adapted target trajectory
S control command
FS1, FS2 driving lanes
ODD area
S1-S9 steps

1. A method for laterally guiding a motor vehicle, the method comprising:
detecting driving lane boundaries using at least one surroundings sensor system and/or swarm data;
generating steering instructions for a steering system based on the detected driving lane boundaries to maintain the motor vehicle on a target trajectory;
enabling a motor vehicle driver to adapt the target trajectory, resulting in an adapted target trajectory;
generating steering instructions for the steering system based on the adapted target trajectory to maintain the motor vehicle on the adapted target trajectory;
identifying areas where the motor vehicle driver is permitted to remove their hands from a steering handle;
detecting whether the motor vehicle driver has removed their hands from the steering handle using at least one sensor system;
transitioning from the adapted target trajectory to the target trajectory based on the detection of hands-off driving within an identified area or upon entering the identified area; and
transmitting corresponding steering instructions to the steering system to maintain the motor vehicle on the target trajectory.

2. The method of claim 1, wherein the adapted target trajectory is deleted after transitioning to the target trajectory.

3. The method of claim 1, further comprising enabling the motor vehicle driver to adapt the target trajectory or the adapted target trajectory while within an identified area, provided the motor vehicle driver has their hands on the steering handle.

4. The method of claim 3, wherein the adaptation of the target trajectory or the adapted target trajectory within an identified area differs in at least one parameter from the adaptation process outside the identified area.

5. The method of claim 1, wherein, upon detecting hands-off driving outside an identified area, the adapted target trajectory is maintained, and the motor vehicle driver is prompted to place their hands back on the steering handle.

6. The method of claim 5, further comprising transitioning to the target trajectory and preparing for an emergency stop if the motor vehicle driver fails to place their hands on the steering handle within a predefined time.

7. The method of claim 1, wherein transitioning from the adapted target trajectory to the target trajectory occurs over a predefined time or distance to ensure a smooth transition.

8. A device for laterally guiding a motor vehicle, the device comprising:
at least one assistance system;
at least one surroundings sensor system and/or access to a database of swarm data;
a sensor system configured to detect whether a motor vehicle driver has removed their hands from a steering handle;
an input unit configured to receive an adaptation to a target trajectory from the motor vehicle driver;
a unit for position determination configured to identify areas where the motor vehicle driver is permitted to remove their hands from the steering handle; and
a control unit configured to:
generate steering instructions for a steering system to maintain the motor vehicle on a target trajectory based on data from the surroundings sensor system and/or swarm data;
generate steering instructions based on the adaptation to maintain the motor vehicle on an adapted target trajectory;
transition from the adapted target trajectory to the target trajectory upon detecting hands-off driving within an identified area or upon entering the identified area; and
transmit corresponding steering instructions to the steering system to maintain the motor vehicle on the target trajectory.

9. The device of claim 8, wherein the control unit is configured to delete the adapted target trajectory after transitioning to the target trajectory.

10. The device of claim 8, wherein the control unit is further configured to enable the motor vehicle driver to adapt the target trajectory or the adapted target trajectory while within an identified area, provided the motor vehicle driver has their hands on the steering handle.

11. The device of claim 10, wherein the control unit is configured to allow the adaptation of the target trajectory or the adapted target trajectory within an identified area to differ in at least one parameter from the adaptation process outside the identified area.

12. The device of claim 8, wherein the control unit is configured to maintain the adapted target trajectory upon detecting hands-off driving outside an identified area and to prompt the motor vehicle driver to place their hands back on the steering handle.

13. The device of claim 12, wherein the control unit is configured to transition to the target trajectory and prepare for an emergency stop if the motor vehicle driver fails to place their hands on the steering handle within a predefined time.

14. The device of claim 8, wherein the control unit is configured to transition from the adapted target trajectory to the target trajectory over a predefined time or distance.

15. A device for guiding a motor vehicle, the device comprising:
at least one surroundings sensor system configured to detect driving lane boundaries and/or receive swarm data;
a sensor system configured to detect whether a motor vehicle driver has removed their hands from a steering handle;
an input unit configured to receive an adaptation to a target trajectory from the motor vehicle driver;
a unit for position determination configured to identify areas where the motor vehicle driver is permitted to remove their hands from the steering handle; and
a control unit configured to:
generate steering instructions for a steering system to maintain the motor vehicle on a target trajectory based on data from the surroundings sensor system and/or swarm data;
generate steering instructions to maintain the motor vehicle on an adapted target trajectory based on the adaptation received from the input unit;
transition from the adapted target trajectory to the target trajectory upon detecting hands-off driving within an identified area or upon entering the identified area; and
transmit the steering instructions to the steering system.

16. The device of claim 15, wherein the surroundings sensor system includes at least one of a camera, radar, LIDAR, or ultrasonic sensor.

17. The device of claim 15, wherein the data related to areas where hands-off driving is permitted is stored in a digital map or retrieved from a remote server.

18. The device of claim 15, wherein the control unit is further configured to delete the adapted target trajectory after transitioning to the target trajectory.

19. The device of claim 15, wherein the control unit is further configured to enable the motor vehicle driver to adapt the target trajectory or the adapted target trajectory while the driver has their hands on the steering handle.

20. The device of claim 19, wherein the adaptation of the target trajectory or the adapted target trajectory within an identified area differs in at least one parameter from the adaptation process outside the identified area.
